(19) United States
(12) Patent Application Publication
(10) Pub. No.: US 2023/0379568 A1
(43) Pub. Date: Nov. 23, 2023

(54) WEAREABLE CAMERA WITH GESTRUE-BASED CONTROL

(71) Applicant: Raja Singh Tuli, Montreal (CA)

(72) Inventor: Raja Singh Tuli, Montreal (CA)

(21) Appl. No.: 18/197,918

(22) Filed: May 16, 2023

Related U.S. Application Data
(60) Provisional application No. 63/342,706, filed on May 17, 2022.

(51) Int. Cl. H04N 23/611; H04N 23/58

(52) U.S. Cl. CPC H04N 23/611; H04N 23/58

(57) ABSTRACT

A wearable camera is provided comprising: a housing; and a camera lens supported by the housing and configured to capture an image or video. When the wearable camera is worn on a user's body, the camera lens is configured to monitor the forward proximity of the user's upper body in order to capture or sense a hand gesture by the user, and is configured to transition to capture the image or video in response to the hand gesture

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

The present disclosure relates to wearable cameras, and in particular to wearable cameras with gesture-based control.

### Description of Related Art

Cameras are used to capture an image or a video in a variety of circumstances. As a specific type of cameras, wearable cameras are typically worn on a user's body, e.g. at her/his temple, shoulder or chest, to capture image or video of a scene or event e.g. in front of the user.

For wearable cameras, it is desirable to minimize their size to facilitate their portability. Therefore, wearable cameras have in general a small form factor, which increase the need to reduce the physical buttons on the wearable cameras and the need for gesture-based control.

Furthermore, in many circumstances, it is desirable to capture an image or a video with minimal intervention and disturbance.

Therefore, a need exists for a wearable camera and its gesture-based control to capture image or video.

### BRIEF SUMMARY OF THE INVENTION

Embodiments are presented herein of, inter alia, a wearable camera with gesture-based control.

In an embodiment of the present disclosure, a wearable camera is provided comprising: a housing; and a camera lens supported by the housing and configured to capture an image or video. When the wearable camera is worn on a user's body, the camera lens is configured to monitor the forward proximity of the user's upper body in order to capture or sense a hand gesture by the user, and is configured to transition to capture the image or video in response to the hand gesture.

### BRIEF DESCRIPTION OF THE DRAWINGS

The various preferred embodiments of the present invention described herein can be better understood by those skilled in the art when the following detailed description is read with reference to the accompanying drawings. The components in the figures are not necessarily drawn to scale and any reference numeral identifying an element in one drawing will represent the same element throughout the drawings. The figures of the drawing are briefly described as follows.

FIG. 1 schematically illustrates an exemplary wearable camera according to an embodiment of the present disclosure;

FIG. 2 illustrates a schematic block diagram of an exemplary wearable camera according to an embodiment of the present disclosure;

FIG. 3 schematically illustrates an exemplary hand gesture for capturing image, according to an embodiment of the present disclosure;

FIG. 4 schematically illustrates an exemplary hand gesture for capturing video, according to an embodiment of the present disclosure;

FIG. 5 schematically depicts the difference in perspectives resulted from the location offset between the camera and the user's eyes.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE INVENTION

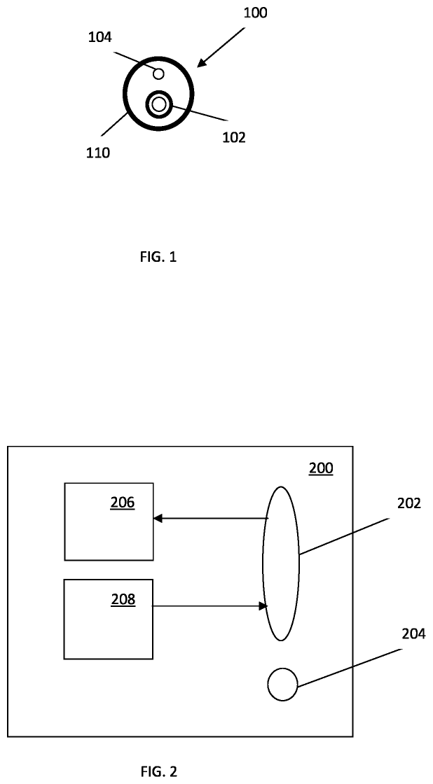

FIG. 1 illustrates an exemplary wearable camera 100 according to an embodiment of the present disclosure. In the embodiment of the present disclosure as illustrated in FIG. 1, the exemplary wearable camera 100 takes a form of a small button. However, it is appreciated that the wearable camera according to the present disclosure is not limited to the specific form as illustrated in FIG. 1. Instead, a wearable camera may take a variety of forms, such as e.g. necklace, goggles, etc. In FIG. 1, the wearable camera 100 is shown to comprise a housing 110 and a camera lens 102. Optionally, the wearable camera 100 may further comprise a flash 104, in an embodiment of the present disclosure.

The camera lens 102 is movable in its capturing direction so that the wearable camera 100 can capture image or video in different directions. As an example, the camera lens 102 is capable to swivel in the housing 110 so as to change where it points in order to get good perspective. Like in the conventional cameras, the camera lens 102 is capable of zooming in and zooming out in order to adjust the size of the field of view for the camera 100.

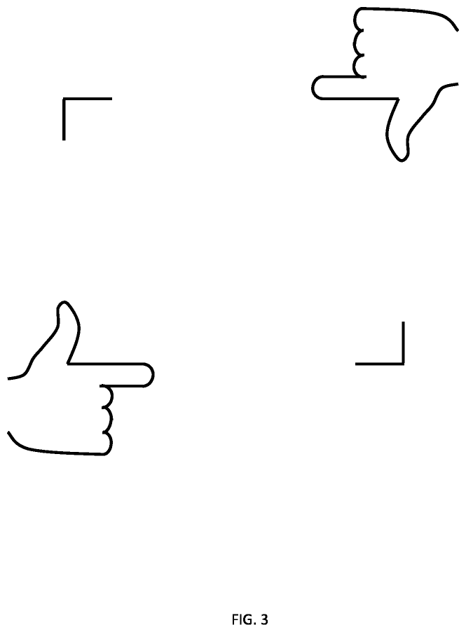

FIG. 2 illustrates a schematic block diagram of an exemplary wearable camera 200 according to an embodiment of the present disclosure. As illustrated in FIG. 2 and similar to the wearable camera 100, the wearable camera 200 comprises a camera lens 202 and optionally a flash 204. Optionally, the camera 200 may further comprise a communication module 206 to communicate with an external electronic device such as e.g. smart phone, in an embodiment of the present disclosure.

The communication module 206 communicates with an external electronic device by means of a wireless communication protocol such as Bluetooth, Near-field Communication (NFC), Wi-Fi, Ultra Wideband (UWB), or another wireless communication protocol. With the communication module 206, the image or video captured by the wearable camera 200 may be transferred to an external electronic device, e.g. for storage or processing.

In order for a small form factor and/or for a convenient manipulation, the wearable camera 200 is configurable to be manipulate or activated with a hand gesture by the user, according to an embodiment of the present disclosure. To this end, the camera lens 202 is configured to monitor the forward proximity of the user's upper body e.g. in front of the user's eyes or chest in order to capture or sense a hand gesture by the user, when the wearable camera 200 is worn on a user's body, in an embodiment of the present disclosure.

As an example, the camera lens 202 may be configured to continuously monitor the forward proximity of the user's upper body in order to capture or sense a hand gesture by the user, when the wearable camera 200 is worn on a user's body. As another example, the camera lens 202 may be normally in standby or sleep mode, and be configured to be woken up by an input from a user (e.g. a tap) and to then monitor the forward proximity of the user's upper body in order to capture or sense a hand gesture by the user, when the wearable camera 200 is worn on a user's body.

In order to activate the wearable camera 200 to capture an image or video, the user who wears the wearable camera 200 provides a hand gesture. As an example, the user stretches out one or both of her/his arms, positions one or both of her/his hands in front of her/his body e.g. upper body, and make hand gesture.

In one aspect, in order to activate the wearable camera 200 to capture an image, the user who wears the wearable camera 200 provides an image capturing hand gesture, e.g. provides a frame virtually with two hands as illustrated in FIG. 3. In response to capturing the image capturing hand gesture, the wearable camera 200 transitions to capture an image of the scene or event in the field of view as defined by the image capturing hand gesture, e.g. in the frame virtually defined by the user's two hands.

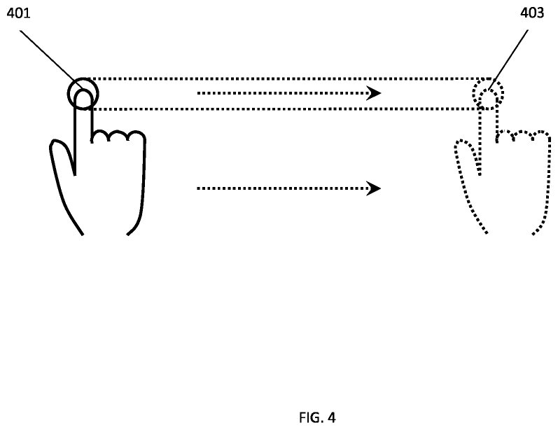

On the other hand, in order to activate the wearable camera 200 to capture a video, the user who wears the wearable camera 200 provides a video capturing hand gesture, e.g. swipes one of her/his fingers in the air with the start 401 and end 403 of the swipe defining the field of view to be captured in the video as illustrated in FIG. 4. In response to capturing the video capturing hand gesture, the wearable camera 200 transitions to capture a video of the scene or event in the field of view as defined by the video capturing hand gesture. As an example, the start 401 and end 403 of the finger swipe define the left and right edge of the field of view respectively and the line connecting the start 401 and end 403 of the finger swipe is positioned e.g. at the top or at the bottom or at the middle of the field of view in the vertical direction.

It is to be noted that, the image and video capturing hand gestures as illustrated in FIGS. 3 and 4 are for illustrative purposes only, and do not intend to limit the scope of the present disclosure. For example, it is envisaged that the image and/or video capturing hand gestures may simply be the user pointing to a location with her/his finger or hand, in which case the field of view to be captured may be determined by positioning the location at the center of the field of view and delimiting the field of view in relation to that center with a preset parameter.

It is understood that the user provides her/his hand gesture in relation to her/his vision or eyes, that is, the field of view defined by the user's hand gesture is chosen by the user in relation to her/his vision or eyes, i.e. based on the scene seen by the user in that field of view. However, due to the location offset between the camera and the user's eyes, the wearable camera cannot capture the same scene as that seen by the user when the camera lens simply is directed towards the user's hand gesture for capturing.

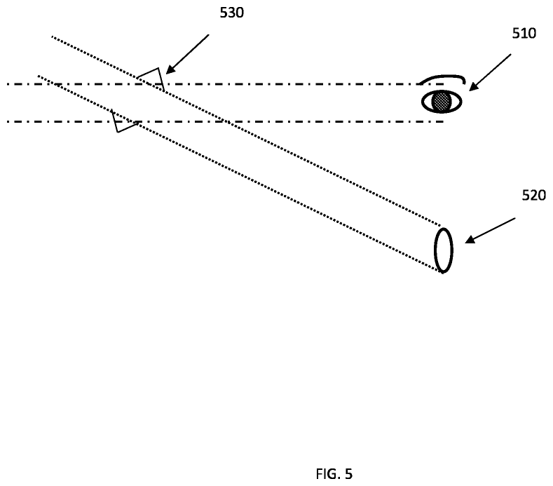

As an example, FIG. 5 schematically depicts the difference in perspectives resulted from the location offset between the camera and the user's eyes. FIG. 5 schematically depicts a wearable camera 520, the user's eyes 510, and the field of view 530 e.g. defined by the user's hand gesture. Dot-dash lines from the user's eyes 510 represent the line of sight from the user's eyes 510, while dashed lines from the wearable camera 520 represent the line of sight from the wearable camera 520. From FIG. 5, it is clear that with respect to a same field of view e.g. defined by the user's hand gesture, two different scenes will be sensed or captured by the user's eyes and the wearable camera due to their location offset.

Accordingly, when capturing an image or video based on the hand gesture, the wearable camera needs to change perspective based on the locations of the camera, the user's eyes, and the hand gesture, so as to capture the intended image or video that the user really wants, i.e. a same image or video as that seen by the user in the field of view as defined by the hand gesture.

Referring back to FIG. 2, the wearable camera 200 may, therefore, further comprise a perspective transformation unit 208 configured to transform the perspective of the wearable camera 200 for the image or video capturing in response to the hand gesture by the user, such that the wearable camera 200 captures a same image or video as that seen by the user in the field of view as defined by the hand gesture.

It is understood that, viewing from different angles might results in parallax error, i.e. the perceived or apparent shift. In order to obtain accurate image or video, the wearable camera 200 conducts image adjustment or processing to reduce or eliminate parallax error, in an embodiment of the present disclosure. It is to be noted that, the image adjustment or processing for reducing or eliminating parallax error may be implemented in the perspective transformation unit 208 as described above or by another unit.

Although the embodiments above have been described in considerable detail, numerous variations and modifications will become apparent to those skilled in the art once the above disclosure is fully appreciated. It is intended that the following claims be interpreted to embrace all such variations and modifications.

The invention claimed is:

1. A wearable camera comprising:
a housing; and
a camera lens supported by the housing and configured to capture an image or video;
wherein when the wearable camera is worn on a user, the camera lens is configured to monitors the forward proximity of the user's upper body in order to capture or sense a hand gesture by the user, and is configured to transition to capture the image or video in response to the hand gesture.

2. The wearable camera as claimed in claim 1, wherein the camera lens is movable in its capturing direction.

3. The wearable camera as claimed in claim 2, wherein the camera lens is capable of swiveling in the housing so as to point in a desired direction.

4. The wearable camera as claimed in claim 1, wherein the hand gesture by the user defines the field of view to be captured by the camera lens.

5. The wearable camera as claimed in claim 4, further comprising a perspective transformation unit positioned in the housing and configured to transform the perspective of the wearable lens for the image and/or video capturing in response to the hand gesture, such that the image and/or video captured by the wearable lens is the same as that seen by the user in the field of view as defined by the hand gesture.

6. The wearable camera as claimed in claim 5, wherein the perspective transformation unit is configured to transform the perspective of the wearable lens based on the locations of the camera lens, the user's eyes, and the hand gesture.

7. The wearable camera as claimed in claim 1, wherein the hand gesture by the user comprises:
an image capturing hand gesture to activate the camera lens to capture an image; and
a video capturing hand gesture to activate the camera lens to capture a video.

8. The wearable camera as claimed in claim 7, wherein the image capturing hand gesture comprises the user providing a frame virtually with two hands or the user pointing to a location with her/his finger.

9. The wearable camera as claimed in claim 7, wherein the video capturing hand gesture comprises the user swiping one of her/his fingers in the air or the user pointing to a location with her/his finger.

10. The wearable camera as claimed in claim 1, further comprising a communication module positioned in the housing and configured to transfer the image or video captured by the camera lens to an external electronic device.

11. The wearable camera as claimed in claim 1, wherein when the wearable camera is worn on a user, the camera lens is configured to continuously monitors the forward proximity of the user's upper body in order to capture or sense a hand gesture by the user.

12. The wearable camera as claimed in claim 1, wherein the camera lens is normally in standby or sleep mode, and configured to be woken up by an input from a user and to then monitor the forward proximity of the user's upper body in order to capture or sense a hand gesture by the user.

13. The wearable camera as claimed in claim 12, wherein the input from a user is the user taping on the wearable camera.
